(19) United States
(12) Patent Application Publication
(10) Pub. No.: US 2025/0018397 A1
(43) Pub. Date: Jan. 16, 2025

(54) APPARATUS AND METHODS FOR REACTIONS REQUIRING A CORROSIVE BASE, AND HEAT AND/OR PRESSURE

(71) Applicant: Ken SAVIN, Indianapolis, IN (US)

(72) Inventor: Ken SAVIN, Indianapolis, IN (US)

(21) Appl. No.: 18/770,151

(22) Filed: Jul. 11, 2024

Related U.S. Application Data
(60) Provisional application No. 63/526,287, filed on Jul. 12, 2023.

(51) Int. Cl. B01L 3/00

(52) U.S. Cl. CPC B01L 3/508; B01L 2300/0851; B01L 2300/0858

(57) ABSTRACT

Disclosed herein are apparatuses including a silicone receptacle for reacting a corrosive base with heat and/or pressure, thereby avoiding degradation of structural materials and contamination of the reaction product. Also disclosed are methods for using apparatuses including a silicone receptacle, such as a silicone liner, which is in contact with the corrosive base under reaction conditions including heat and/or pressure.

The present application claims priority to U.S. Provisional Application No. 63/526,287, filed on Jul. 12, 2023, and entitled “APPARATUS AND METHODS FOR REACTIONS REQUIRING A CORROSIVE BASE, AND HEAT AND/OR PRESSURE,” the entire disclosure of which is expressly incorporated by reference herein.

### FIELD OF THE INVENTION

This disclosure generally relates to apparatuses for reactions requiring a corrosive base and heat and/or pressure, such as apparatuses including a silicone receptacle that contacts the corrosive base under reaction conditions, thereby avoiding degradation of structural materials creating the inner reaction chamber of apparatus and contamination of the reaction product. The disclosure further relates to methods of conducting reactions requiring a corrosive base and heat and/or pressure in a silicone receptacle.

### BACKGROUND

Producing paper from corn stove requires reacting a corrosive base, such as sodium hydroxide (NaOH), with precursor ingredients and exposing such reactants to heat and pressure. However, the feasibility of completing such a reaction with known apparatuses and methods is threatened by degradation of the receptacles used in the reaction and resultant contamination of reaction products with receptacle degradants. Improved apparatuses, and methods for using the same, are necessary to facilitate reactions involving corrosive bases to heat, pressure, or a combination thereof.

There exists a need to without causing degradation to the structural materials creating the inner reaction chamber of apparatus, such as the receptacles involved in the reaction. Additionally, there exists a need to avoid producing a reaction product contaminated with the degradants of such structural materials creating the inner reaction chamber of apparatus. Beyond the production of paper from corn stove, improved apparatuses and methods for reacting a corrosive base in the presence of heat and/or pressure have the potential to benefit various other processes of production. For example, facilitating these conditions in the processes of soapmaking, textile manufacturing, and others could improve production efficiency. However, the absence of advantageous apparatuses and methods for facilitating such reactions demonstrates a significant long-felt need. Aspects of the invention disclosed herein address these needs.

### SUMMARY OF THE INVENTION

A first aspect of the invention includes an apparatus including a body having an outer housing and an inner chamber, a silicone pressure vessel liner received therein, such as a silicone liner or an adhesive silicone coating, which is not removeable, having an interior space and an exterior surface, and a detachable lid that covers the body.

A second aspect of the invention includes an apparatus including an outer housing and an inner chamber with a detachable lid that covers the body, where a removeable reaction vessel having an inner space and an exterior surface is positioned in the inner chamber; and where a silicone pressure vessel liner, such as a silicone liner or an adhesive silicone coating, is positioned in the inner space of the removeable reaction vessel.

A third aspect of the invention includes methods for exposing a reaction mixture containing a corrosive base to heat and pressure.

A first embodiment is an apparatus including a body having an outer housing and an inner chamber, a silicone pressure vessel liner received therein having an interior space and an exterior surface, and a detachable lid that covers the body.

A second embodiments is an apparatus where the inner chamber includes an interior bottom and side walls, where the exterior surface of the silicone pressure vessel liner contacts the interior bottom and the side walls of the inner chamber.

A third embodiment is an apparatus where the silicone pressure vessel liner is removeable from the inner chamber of the apparatus.

A fourth embodiment is an apparatus where the silicone pressure vessel liner coats the interior bottom and the side walls of the inner chamber.

A fifth embodiment is an apparatus including a body having an outer housing and an inner chamber with a detachable lid that covers the body, where a removeable reaction vessel having an inner space and an exterior surface is positioned in the inner chamber; and where a silicone pressure vessel liner is positioned in the inner space of the removeable reaction vessel.

A sixth embodiment is an apparatus where the inner space of the removeable reaction vessel comprises an inside bottom and side walls; and wherein the exterior surface of the silicone pressure vessel liner contacts the inside bottom and side walls of the removeable reaction vessel.

A seventh embodiment is an apparatus where the silicone pressure vessel liner is removeable from the inner space of the removeable reaction vessel.

An eighth embodiment is an apparatus where the silicone pressure vessel liner coats the inside bottom and side walls of the removeable reaction vessel.

A ninth embodiment is an apparatus where the interior space of the silicone pressure vessel liner has a volume capacity of up to and including about 100 L, 250 L, 500 L, 750 L, 1000 L, 5000 L, 10,000 L, 15,000 L, 20,000 L, 25,000 L, or 50,000 L.

A tenth embodiment is an apparatus where the interior space of the silicone pressure vessel liner has a volume capacity of about 1 L, 5 L, 10 L, 15 L, 20 L, 25 L, 30 L, 35 L, 40 L, 45 L, 50 L, 55 L, 60 L, 65 L, 70 L, 75 L, 80 L, 85 L, 90 L, 95 L, or 100 L.

An eleventh embodiment is an apparatus that is a countertop pressure cooker or a reactor.

A twelfth embodiment is an apparatus that is a flow chemical reactor, a stirred tank reactor, a high-pressure reactor, a hydrothermal reactor, a supercritical fluid reactor, a batch reactor, a fixed bed reactor, a tubular reactor, a continuous stirred reactor, a packed bed reactor, or a multi-purpose reactor.

A thirteenth embodiment is a method for performing a chemical reaction in the silicone pressure vessel liner of any of the preceding embodiments, involving exposing a reaction mixture containing a corrosive base to heat and pressure.

A fourteenth embodiment is a method for exposing a reaction mixture containing a corrosive base to heat and pressure, where the corrosive base is in contact with a material including silicone and the material including silicone is housed within a pressure vessel.

A fifteenth embodiment is a method for exposing a reaction mixture containing a corrosive base to heat and pressure, where the corrosive base is aluminum hydroxide (Al(OH)₃), barium hydroxide (Ba(OH)₂), beryllium hydroxide (Be(OH)₂), calcium hydroxide (Ca(OH)₂), cesium hydroxide (CsOH), lithium hydroxide (LiOH), magnesium hydroxide (Mg(OH)₂), potassium hydroxide (KOH), rubidium hydroxide (RbOH), sodium hydroxide (NaOH), strontium hydroxide (Sr(OH)₂), or any combination thereof.

A sixteenth embodiment is a method for exposing a reaction mixture containing a corrosive base to heat and pressure, where the concentration % (v/v) of the corrosive base in the reaction mixture is about 1% to 95%.

A seventeenth embodiment is a method for exposing a reaction mixture containing a corrosive base to heat and pressure, where the reaction mixture is exposed to a temperature of up to 250° C. and a pressure of up to 2.0 bar.

An eighteenth embodiment is a method for exposing a reaction mixture containing a corrosive base to heat and pressure, where the method reduces or prevents degradation of structural materials and contamination of the reaction product.

A nineteenth embodiment is a method for exposing a reaction mixture containing a corrosive base to heat and pressure, where the structural materials comprise glass, resin, a metal, ceramic, or a combination thereof.

A twentieth embodiment is a method for exposing a reaction mixture containing a corrosive base to heat and pressure, where the metal is any one of aluminum, copper, iron, steel, or a combination thereof.

### BRIEF DESCRIPTION OF THE FIGURES

The accompanying drawings are included to provide a further understanding of the disclosure and are incorporated in and constitute a part of this specification, illustrate embodiments, and together with the description serve to explain the principles of the disclosure.

FIG. 1 is a drawing of an embodiment of the invention wherein the silicone pressure vessel liner is placed within the interior chamber of the pressure apparatus.

FIG. 2 is a drawing of an embodiment of the invention wherein the silicone pressure vessel liner is a coating or is adhered onto the inner surface of the interior chamber of the pressure apparatus.

FIG. 3 is a drawing of an embodiment of the invention wherein the silicone pressure vessel liner is placed within a removable reaction vessel within the interior chamber of the pressure apparatus.

FIG. 4 is a drawing of an embodiment of the invention wherein the silicone pressure vessel liner is a coating or is adhered onto the inner surface of a removable reaction vessel within the interior chamber of the pressure apparatus.

### DETAILED DESCRIPTION

Experimentation with reaction conditions in the production of paper from corn stove, using a corrosive base in a pressure vessel, resulted in damage to the inner walls of the pressure vessel and an inferior product contaminated with the degradants of the composition of the inner walls of the pressure vessel in contact with the corrosive base. When the corrosive base was heated in solution with water, and especially when heated above 100° C. under pressure, degradation of the inner walls of the pressure vessel in contact with the solution was observed. This was observed in pressure vessels having inner walls composed of different materials, including glass, metal and resin. For example, exposing an NaOH solution to heat and pressure resulted in clouding of the glass and a slippery texture to the glass. In addition to destruction of the material of the inner walls of the pressure vessel and contamination of the reaction product with such degradants, such conditions posed a high risk for a hazardous accident. For example, in pressure vessels having glass inner walls the degradation creates a slippery texture and an increased hazard in handling.

In contrast, experimentation with several silicone-based vessels, such as commercially available silicone bakeware, yielded a favorable product, resulting in neither vessel degradation nor contamination of reaction products. Accordingly, the disclosed apparatuses and methods provide various advantages for performing chemical reactions requiring exposure of a corrosive base to heat and/or pressure. In some aspects, provided are apparatuses including and methods involving use of pressure vessel liners comprising silicone. Such silicone pressure vessel liners are suitable for use in a variety of pressure vessels, such as pressure cookers or reactors, ranging from countertop pressure cookers to large-scale commercial reactors.

### Apparatus

In some aspects, provided is an apparatus comprising a silicone liner positioned within the inner chamber of the apparatus, which is suitable for reacting a corrosive base, such as a corrosive base in water, with additional ingredients or reactants in the presence of heat and pressure, where the corrosive base is in contact with the silicone liner and not in contact with the interior walls of the inner chamber.

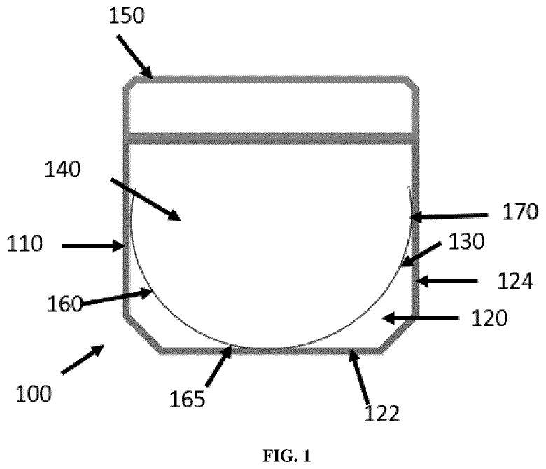

As shown in FIG. 1, in some embodiments, the apparatus comprises a body 100 having an inner chamber 120, a silicone liner 130 having an interior space 140. The apparatus also has an outer housing 110 that may or may not be in direct contact with the exterior walls of the inner chamber, and a detachable lid 150, wherein the silicone liner 130 contacts the interior bottom 122 and side walls 124 of the inner chamber 120. In some embodiments, the silicone liner is removable. In some embodiments, the silicone pressure vessel liner 130 is positioned in a water bath, i.e., the exterior surface of the silicone pressure vessel liner 160 contacts water contained within the inner chamber 120 of the apparatus.

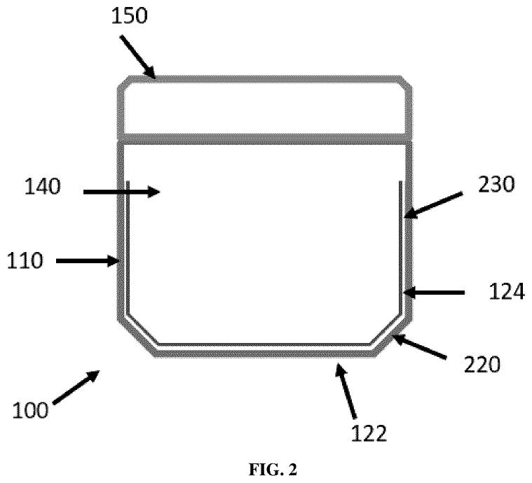

As shown in FIG. 2, in other embodiments, the silicone liner is not removable. In embodiments where the silicone liner is not removable the liner may be a silicone coating 230. In such embodiments, the silicone coating 230 is adhered to the interior surface of the inner chamber 220.

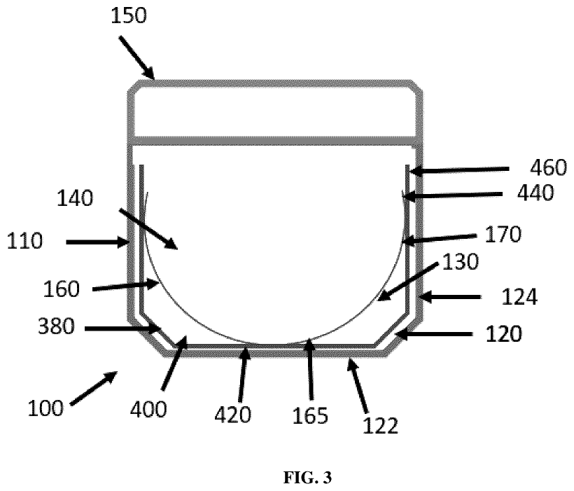

In some embodiments, as shown in FIG. 3, the silicone pressure vessel liner 130 is positioned within a removeable reaction vessel 380 within the inner chamber 120 of the apparatus. The removeable reaction vessel has an inner space 400 having an inside bottom 420 and side walls 440, the reaction vessel being an independent structure that may be moved into and out of the inner chamber 120 of the apparatus 100. In some embodiments, the removable reaction vessel 380 is positioned in a water bath, i.e., the outer surface of the removeable reaction vessel 460 contacts water contained within the inner chamber 120 of the apparatus. In some embodiments, the silicone pressure vessel liner 130 is positioned in a water bath, i.e., the exterior surface of the silicone pressure vessel liner 160 contacts water contained within the inner space of the removeable reaction vessel 400. In some embodiments, the removable reaction vessel 380 and the silicone pressure vessel liner 130 are positioned in water baths.

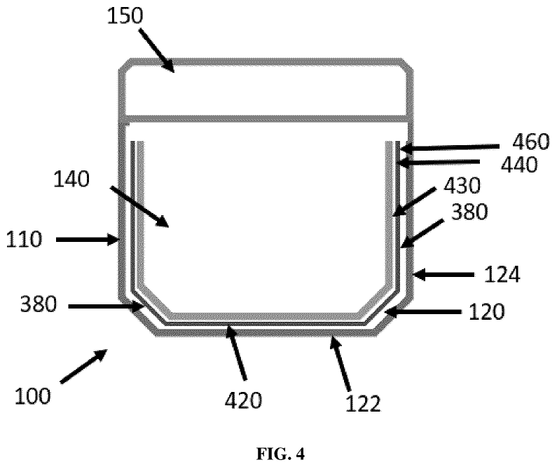

In some embodiments, as shown in FIG. 4, the silicone pressure vessel liner 430 is adhered or a coating on the inner surface of the removeable reaction vessel 380. In some embodiments, the removable reaction vessel 380 is positioned in a water bath, i.e., the outer surface of the removeable reaction vessel 460 contacts water contained within the inner chamber 120 of the apparatus.

The contents of the apparatus, such as the pressure vessel, may be sealed, e.g., to facilitate increasing pressure. The seal may be air-tight, water-tight, gas-tight, vacuum sealed, pressure sealed, liquid-tight, a hermetic seal, a chemical-resistant seal, or a mechanical seal. In some embodiments, the lid creates a seal between the lid and the outer housing. In some embodiments, the outer housing and the lid comprise matching teeth for locking engagement upon rotating the lid into closure.

In some embodiments, the apparatus is a countertop cooker device, such as a countertop pressure cooker, comprising the silicone pressure vessel liner as described herein. In some embodiments, the apparatus is a slow cooker, a pressure cooker, a rice cooker, or a steam cooker comprising the silicone pressure vessel liner as described herein. Exemplary apparatuses that may be used within the scope of the present disclosure include electric pressure cookers, described in, e.g., US20200128997A1, US20200128998A1, US20220061576A1, US20220142396A1, US20200359824A1, US20230070803A1, and US20030010216A1.

In some embodiments, the apparatus is a reactor comprising the silicone pressure vessel liner as described herein. In some embodiments, the apparatus is a flow chemical reactor, stirred tank reactor, a high-pressure reactor, a hydrothermal reactor, a supercritical fluid reactor, a batch reactor, a fixed bed reactor, a tubular reactor, a continuous stirred reactor, a packed bed reactor, or a multi-purpose reactor comprising the silicone pressure vessel liner as described herein.

In some embodiments, the apparatus comprising the silicone pressure vessel liner has the silicone liner inserted into the inner chamber of the apparatus, such that the silicone pressure vessel liner contacts the bottom and sides of the apparatus. In some embodiments, the apparatus comprising the silicone pressure vessel liner has silicone adhering to the inner chamber of the apparatus with silicone, such as a silicone coating, such that the silicone coating contacts the bottom and sides of the apparatus. In some embodiments, the apparatus comprising the silicone pressure vessel liner has the silicone liner or the silicone coating positioned in the apparatus such that the silicone material contacts and separates a corrosive base from the various bodies and chambers of the apparatus, such as those of an outer housing or the removable reaction vessel.

### Silicone Pressure Vessel Liner

In some embodiments, the silicone pressure vessel liner 130 has a closed bottom end 165, one or more side walls 170 extending upwardly from the closed bottom end. The silicone pressure vessel liner may be a continuous piece or may be composed of multiple pieces seamed together to form a continuous piece. Herein, the silicone pressure vessel liner may be referred to as a silicone receptacle, silicone vessel, silicone container, silicone coating, or a silicone inner housing.

In some embodiments, the silicone pressure vessel liner comprises polydimethylsiloxane (PDMS), phenyl methyl silicone (PVMQ), poly (dimethylsiloxane-co-methylvinylsiloxane) (PDMSc), vinyl methyl silicone (VMQ), phenylmethylsiloxane (PMSQ), fluorosilicone (FVMQ), or a combination thereof.

Known compositions of silicone may be used as the silicone pressure vessel liner in the various embodiments of the apparatus disclosed herein, including commercially available silicone bakewear and liners. Silicone compositions suitable for use in the disclosed apparatuses are described in, e.g., US20170354293A1, U.S. Pat. No. 6,417,263B1, WO2008109865A2, U.S. Pat. Nos. 6,111,003A, 5,708,067A, 5,552,466A, and 4,034,140A.

In additional examples, the silicone pressure vessel liner may have a composition similar to that of commercially available silicone bakeware. Silicone bakeware primarily comprises silicone, a synthetic polymer derived from silicon, oxygen, carbon, and hydrogen. The heat-resistant and non-stick properties, along with the durability, of silicone may be enhanced by addition of various additives, fillers, and reinforcing agents, e.g., silica, fiberglass, titanium dioxide, carbon black, iron oxides, antioxidants, fillers and extenders, such as calcium carbonate or talc, and plasticizers. Silicone bakeware may also comprise pigments to impart a desired color.

In some embodiments, the silicone pressure vessel liner is removable. In some embodiments, the silicone pressure vessel liner comprises handles, such as for removing the receptacle. In some embodiments, the silicone pressure vessel liner comprises a contoured bottom or a rounded bottom. In some embodiments, the sides of the silicone pressure vessel liner have a round and hollow shape, such as a cylindrical, tube-like, pipe-like, or tubiform shape.

In some embodiments, the silicone pressure vessel liner has a flat bottom. In some embodiments, the silicone pressure vessel liner has a flat bottom having at least three corners. In some embodiments, the silicone pressure vessel liner comprises a flat bottom having three corners, four corners, five corners, six corners, seven corners, eight corners, or nine corners. In some embodiments, the silicone pressure vessel liner comprises straight sides. In some embodiments, the silicone pressure vessel liner comprises rounded sides. In some embodiments, the silicone pressure vessel liner comprises contoured sides.

In some embodiments, the silicone pressure vessel liner is not removable. In some embodiments, the silicone pressure vessel liner is a coating on the inner surface of the inner chamber of the apparatus. In some embodiments, the silicone pressure vessel liner is a coating on the inner surface of a removeable reaction vessel that is moved in and out of the inner chamber of the apparatus.

In some embodiments, the silicone pressure vessel liner has a thickness of at least 1 mm, 10 mm, 50 mm, or 100 mm. In some embodiments, the silicone pressure vessel liner has a thickness of less than about 10 cm, 50 cm, or 100 cm. In some embodiments, the silicone pressure vessel liner has a thickness of about 0 mm, 0.5 mm, 1 mm, 5 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, or 100 mm.

In some embodiments, where the silicone pressure vessel liner is a coating on the inner walls of the inner chamber of the apparatus or the inner walls of the reaction vessel, the silicone pressure vessel coating has a thickness of at least 1 mm, 10 mm, 50 mm, or 100 mm. In some embodiments, the silicone pressure vessel coating has a thickness of less than about 10 cm, 50 cm, or 100 cm. In some embodiments, the silicone pressure vessel coating has a thickness of about 0 mm, 0.5 mm, 1 mm, 5 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, or 100 mm.

A mold may be utilized to make the silicone pressure vessel liner. In some embodiments, liquid silicone may be injected into the mold at a desired thickness to create the receptacle. In some embodiments, the mold has the same dimensions as an inner chamber of an apparatus that is capable of providing elevated temperature and/or elevated pressure to the inner chamber. In some embodiments, the mold does not have the same dimensions as the inner chamber of an apparatus but is still able to fit within the inner chamber. In some embodiments, the mold replicates the inner chamber of a housing that the silicone liner is placed in. Those of skill in the art would appreciate that the desired dimensions of the silicone pressure vessel liner will be dependent upon the interior size and shape of the inner chamber of the pressure apparatus.

### Methods

In some aspects, provided herein are methods for exposing a reaction mixture comprising a corrosive base to heat and pressure, where the corrosive base is in contact with a material comprising silicone, such as the silicone pressure vessel liner of the apparatuses described herein. In some embodiments, the material comprising silicone is housed within an inner chamber of the pressure apparatus. In some embodiments, the material comprising silicone is housed within a reaction vessel that is placed within the inner chamber of the pressure apparatus. In some embodiments, disclosed methods prevent degradation of the material composition of the inner walls of the apparatus inner chamber and/or reaction vessel relative to conducting the reaction in the absence of a material comprising silicone. Degradation of inner chamber walls and the reaction vessel, and subsequent contamination of reactants, is avoided by separating surfaces of the inner chamber walls and/or reaction vessel from the corrosive base with a silicone material, such as the silicone liners and coating described herein.

### Reactants and Reaction Conditions

In some embodiments, the corrosive base is aluminum hydroxide (Al(OH)₃), barium hydroxide (Ba(OH)₂), beryllium hydroxide (Be(OH)₂), calcium hydroxide (Ca(OH)₂), caesium hydroxide (CsOH), lithium hydroxide (LiOH), magnesium hydroxide (Mg(OH)₂), potassium hydroxide (KOH), rubidium hydroxide (RbOH), sodium hydroxide (NaOH), strontium hydroxide (Sr(OH)₂), or any combination thereof.

In some embodiments, the corrosive base is not diluted prior to exposure to heat and/or pressure. In some embodiments, the corrosive base is diluted prior to exposure to heat and/or pressure, such as by addition of other ingredients in the reaction mixture. In some embodiments, the concentration % (v/v) of the corrosive base in the reaction mixture is less than 100%, less than 95%, less than 90%, less than 85%, less than 80%, less than 75%, less than 70%, less than 65%, less than 60%, less than 55%, less than 50%, less than 45%, less than 40%, less than 35%, less than 30%, less than 25%, less than 20%, less than 15%, less than 10%, or less than 5%.

In some embodiments, the concentration % (v/v) of the corrosive base in the reaction mixture is about 1% to 100%, 5% to 100%, 10% to 100%, 15% to 100%, 20% to 100%, 25% to 100%, 30% to 100%, 35% to 100%, 40% to 100%, 45% to 100%, or 50% to 100%, 55% to 100%, 60% to 100%, 65% to 100%, 70% to 100%, 75% to 100%, 80% to 100%, 85% to 100%, 90% to 100%, or 95% to 100%, inclusive.

In some embodiments, the concentration % (v/v) of the corrosive base in the reaction mixture is about 1% to 99%, 5% to 95%, 10% to 90%, 15% to 85%, 20% to 80%, 25% to 75%, 30% to 70%, 35% to 75%, 40% to 70%, 45% to 65%, or 50% to 60%.

In some embodiments, the concentration % (v/v) of the corrosive base in the reaction mixture is about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, or about 95%. In some embodiments, the corrosive base is diluted in additional ingredients in the reaction mixture. In some embodiments, the corrosive base is diluted in water.

In some embodiments the molarity of the corrosive base added to the reaction mixture is at least 1M, 5 M, 10 M, 15 M, 20 M, 25 M, or 50 M. In some embodiments the molarity of the base added to the reaction mixture ranges from about 1 M to 25 M, 5 M to 25 M, 10 M to 25 M, 1 M to 20 M, 5 M to 20 M, 10 M to 20 M, 1 M to 15 M, 5 M to 15 M, or 10 M to 15 M. In some embodiments the molarity of the corrosive base added to the reaction mixture is about 0.1 M, 0.5 M, 1 M, 1.5 M, 2 M, 2.5 M, 3 M, 3.5 M, 4 M, 4.5 M, 5 M, 5.5 M, 6 M, 6.5 M, 7 M, 7.5 M, 8 M, 8.5 M, 9 M, 9.5 M, 10 M, 10.5 M, 11 M, 11.5 M, 12 M, 12.5 M, 13 M, 13.5 M, 14 M, 14.5 M, 15 M, 15.5 M, 16 M, 16.5 M, 17 M, 17.5 M, 18 M, 18.5 M, 19 M, 19.5 M, or 20 M.

In some embodiments, the pH of the reaction mixture comprising the corrosive base is at least 7.0, 8.0, 9.0, 10.0, 11.0, 12.0, or 13.0. In some embodiments, the pH of the reaction mixture comprising the corrosive base ranges from 7.0 to 14.0, 8.0 to 14.0, 9.0 to 14.0, 10.0 to 14.0, 11.0 to 14.0, 12.0 to 14.0, or 13.0 to 14.0. In some embodiments, the pH of the reaction mixture comprising the corrosive base is about 9, 9.1, 9.2, 9.3, 9.4, 9.5, 9.6, 9.7, 9.8, 9.9, 10, 10.1, 10.2 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, 13.9, or 14.

In some embodiments, the corrosive base is aluminum hydroxide (Al(OH)₃), barium hydroxide (Ba(OH)₂), beryllium hydroxide (Be(OH)₂), calcium hydroxide (Ca(OH)₂), caesium hydroxide (CsOH), lithium hydroxide (LiOH), magnesium hydroxide (Mg(OH)₂), potassium hydroxide (KOH), rubidium hydroxide (RbOH), sodium hydroxide (NaOH), or strontium hydroxide (Sr(OH)₂).

In some embodiments, the contents of the inner chamber of the apparatus comprising the silicone pressure vessel liner are exposed to heat. In some embodiments, the contents of the inner chamber of the apparatus comprising the silicone receptacle are exposed to temperatures of up to and including about 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., 200° C., 205° C., 210° C., 215° C., 220° C., 225° C., 230° C., 235° C., 240° C., 245° C., 250° C., 255° C., 260° C., 265° C., 270° C., 275° C., 280° C., 285° C., 290° C., 295° C., 300° C., 305° C., 310° C., 315° C., 320° C., 325° C., 330° C., 335° C., 340° C., 345° C., 350° C., 355° C., 360° C., 365° C., 370° C., 375° C., 380° C., 385° C., 390° C., 395° C., 400° C., 405° C., 410° C., 415° C., 420° C., 425° C., 430° C., 435° C., 440° C., 445° C., 450° C., 455° C., 460° C., 465° C., 470° C., 475° C., 480° C., 485° C., 490° C., 495° C., 500° C., 505° C., 510° C., 515° C., 520° C., 525° C., 530° C., 535° C., 540° C., 545° C., 550° C., 555° C., 560° C., 565° C., 570° C., 575° C., 580° C., 585° C., 590° C., 595° C., or 600° C. In some embodiments, the contents of the inner chamber of the apparatus comprising the silicone liner exposed to heat are also exposed to pressure.

In some embodiments, the contents of the inner chamber of the apparatus comprising the silicone liner are exposed to pressure. In some embodiments, the contents of the inner chamber of the apparatus comprising the silicone liner are exposed to pressures of up to and including about 0.1 bar, 0.2 bar, 0.3 bar, 0.4 bar, 0.5 bar, 0.6 bar, 0.7 bar, 0.8 bar, 0.9 bar, 1 bar, 1.1 bar, 1.2 bar, 1.3 bar, 1.4 bar, 1.5 bar, 1.6 bar, 1.7 bar, 1.8 bar, 1.9 bar, 2 bar, 2.1 bar, 2.2 bar, 2.3 bar, 2.4 bar, 2.5 bar, 2.6 bar, 2.7 bar, 2.8 bar, 2.9 bar, 3 bar, 3.1 bar, 3.2 bar, 3.3 bar, 3.4 bar, 3.5 bar, 3.6 bar, 3.7 bar, 3.8 bar, 3.9 bar, 4 bar, 4.1 bar, 4.2 bar, 4.3 bar, 4.4 bar, 4.5 bar, 4.6 bar, 4.7 bar, 4.8 bar, 4.9 bar, 5 bar, 5.1 bar, 5.2 bar, 5.3 bar, 5.4 bar, 5.5 bar, 5.6 bar, 5.7 bar, 5.8 bar, 5.9 bar, 6 bar, 6.1 bar, 6.2 bar, 6.3 bar, 6.4 bar, 6.5 bar, 6.6 bar, 6.7 bar, 6.8 bar, 6.9 bar, and 7 bar. In some embodiments, the contents of the inner chamber of the apparatus comprising the silicone pressure vessel liner exposed to pressure are also exposed to heat.

In some embodiments, the contents of the inner chamber of the apparatus comprising the silicone pressure vessel liner are exposed to pressures of up to and including about 0 bar, 10 bar, 20 bar, 30 bar, 40 bar, 50 bar, 60 bar, 70 bar, 80 bar, 90 bar, 100 bar, 110 bar, 120 bar, 130 bar, 140 bar, 150 bar, 160 bar, 170 bar, 180 bar, 190 bar, 200 bar, 210 bar, 220 bar, 230 bar, 240 bar, 250 bar, 260 bar, 270 bar, 280 bar, 290 bar, or 300 bar. In some embodiments, the contents of the inner chamber of the apparatus comprising the silicone liner exposed to pressure are also exposed to heat.

### Reaction Equipment

In some examples, the apparatus is capable of applying increased pressure and/or increased heat within the inner chamber of the apparatus. In some embodiments, the pressure apparatus is commercially sized for housing large volumes of reaction materials, such as volumes greater than 50 L. In some embodiments, the pressure apparatus is an autoclave, a stirred tank reactor, a high-pressure reactor, a hydrothermal reactor, a supercritical fluid reactor, a batch reactor, a fixed bed reactor, a tubular reactor, a continuous stirred reactor, a packed bed reactor, or a multi-purpose reactor. In some embodiments, the pressure apparatus is sized placement on a countertop or benchtop and thereby houses smaller volumes of reaction materials, such as volumes less than 10 L. Examples of countertop sized reaction equipment include, but is not limited, a stove-top pressure cooker, a countertop pressure cooker, a commercial pressure cooker, a crock pot, a stockpot, a Dutch oven, or a kettle.

The volume capacity of the interior space formed by the silicone liner will often be determined by the volume of the inner chamber of the apparatus. In some embodiments, the interior space formed by the silicone liner has a volume capacity of up to and including about 1500 L, 2000 L, 2500 L, 3000 L, 3500 L, 4000 L, 4500 L, 5000 L, 5500 L, 6000 L, 6500 L, 7000 L, 7500 L, 8000 L, 8500 L, 9000 L, 9500 L, 10,000 L, 10,500 L, 11,000 L, 11,500 L, 12,000 L, 12,500 L, 13,000 L, 13,500 L, 14,000 L, 14,500 L, 15,000 L, 15,500 L, 16,000 L, 16,500 L, 17,000 L, 17,500 L, 18,000 L, 18,500 L, 19,000 L, 19,500 L, 20,000 L, 20,500 L, 21,000 L, 21,500 L, 22,000 L, 22,500 L, 23,000 L, 23,500 L, 24,000 L, 24,500 L, 25000 L, 25,500 L, 26,000 L, 26,500 L, 27,000 L, 27,500 L, 28,000 L, 28,500 L, 29,000 L, 29,500 L, 30,000 L, 30,500 L, 31,000 L, 31,500 L, 32,000 L, 32,500 L, 33,000 L, 33,500 L, 34,000 L, 34,500 L, 35,000 L, 35,500 L, 36,000 L, 36,500 L, 37,000 L, 37,500 L, 38,000 L, 38,500 L, 39,000 L, 39,500 L, 40,000 L, 40,500 L, 41,000 L, 41,500 L, 42,000 L, 42,500 L, 43,000 L, 43,500 L, 44,000 L, 44,500 L, 45,000 L, 45,500 L, 46,000 L, 46,500 L, 47,000 L, 47500 L, 48,000 L, 48,500 L, 49,000 L, 49,500 L, 50,000 L, 75,000 L, or 100,000 L.

In some embodiments, the interior space formed by the silicone liner has a volume capacity of up to and including about 100 L, 250 L, 500 L, 750 L, or 1000 L. In some embodiments, the interior spaced formed by the silicone liner has a volume of about 1 L, 5 L, 10 L, 15 L, 20 L, 25 L, 30 L, 35 L, 40 L, 45 L, 50 L, 55 L, 60 L, 65 L, 70 L, 75 L, 80 L, 85 L, 90 L, 95 L, or 100 L. In some embodiments, the interior space formed by the silicone liner has a volume capacity of about 2 L, 2.5 L, 3 L, 3.5 L, 4 L, 4.5 L, 5 L, 5.5 L, 6 L, 6.5 L, 7 L, 7.5 L, or 8 L.

In some embodiments, the reaction vessel includes any container or vessel known to one of skill in the art suitable for reacting a corrosive base and additional reactants. In some embodiments, the reaction vessel is composed of glass, resin, a metal, ceramic, or a combination thereof. In some embodiments, the metal is any one of aluminum, copper, iron, steel, or a combination thereof.

### Exemplary Methods

Exemplary methods which could be improved by the apparatuses and methods disclosed herein include the process described in Example 1 and various other manufacturing processes now described. Additional processes and methods which employ use of a corrosive base and heat and/or pressure will also benefit from the disclosed apparatuses and such applicable processes and methods will be evident to one of skill in the art.

### Soap Manufacturing

An exemplary process which the disclosed apparatuses and methods offer advantages for is soap making. Sodium hydroxide is used for hard bar soap, while potassium hydroxide is used for liquid soaps. Soap is made simply by dissolving a small amount of an alkali like sodium hydroxide or potassium hydroxide in water, mixing the solution in the oil slowly while stirring it, heating the mixture, and then boiling it for 10-12 minutes, stirring it all the while. The soap formed by the chemical reaction floats to the top of the reaction mixture. The efficiency of the process could be improved if reactants were heated under pressure, which is possible using the apparatuses described herein.

### Manufacturing of Natural or Artificial Fibers and Textiles

Another process of manufacturing which could benefit from the apparatuses and methods described herein is paper making. Around 56% of sodium hydroxide (NaOH) produced is used by industry, 25% of which is used in the paper industry.

### Dyeing and Bleaching

NaOH solutions are used in making and using dyes and bleaches. For example, Vat dyes are essentially insoluble in water and incapable of dyeing fibres directly. However, reduction in alkaline liquor (aqueous NaOH) solution) produces the water-soluble alkali metal salt of the dye. This form is often colorless, in which case it is referred to as a Leuco dye and has an affinity for the textile fibre. Subsequent oxidation reforms the original insoluble dye. In one example, the color of denim is due to indigo, the original vat dye.

Other amphoteric metals are zinc and lead which dissolve in concentrated sodium hydroxide solutions to give sodium zincate and sodium plumbate respectively. Such metals may be added to water, heated, and then used to clean process equipment, storage tanks, etc.

The ability of aggressive bases, such as KOH, to damage the hair shaft cuticle in animal hides facilitates the removal of hair therefrom. The hides are soaked for several hours in a solution of KOH and water to prepare them for the hair removal stage of the tanning process. This same effect is also used to weaken human hair in preparation for shaving. Pre-shave products and some shave creams contain potassium hydroxide to force open the hair cuticle and to act as a hygroscopic agent to attract and force water into the hair shaft, causing further damage to the hair. In this weakened state, the hair is more easily cut by a razor blade.

In the production of rayon, the first step is exposure to aqueous NaOH. To prepare viscose, pulp is treated with aqueous NaOH, typically 16-19% by mass, to form “alkali cellulose,” which has the approximate formula [C6H904—ONa]n. This material is allowed to depolymerize to an extent. The rate of depolymerization, such as ripening or maturing, depends on temperature and is affected by the presence of various inorganic additives, such as metal oxides and hydroxides. Air also affects the ripening process since oxygen causes depolymerization. The alkali cellulose is then treated with carbon disulfide to form sodium cellulose xanthate.

### Manufacturing of Chemical Bases

In some examples, the disclosed methods can be useful in the production of the chemical bases, e.g., chemical reactions for such manufacturing may be conducted in disclosed silicone liners and coatings. In one example, beryllium hydroxide precipitates when alkali is added to beryllium salt solutions and the mixture is boiled. This process could be performed in a silicone lined or coated container to prevent degradation of the equipment, as described herein.

Chemical bases which may be manufactured with use of the apparatuses and methods described herein include but are not limited to barium hydroxide (Ba(OH)₂), calcium hydroxide (Ca(OH)₂), caesium hydroxide (CsOH), lithium hydroxide (LiOH), magnesium hydroxide (Mg(OH)₂), potassium hydroxide (KOH), rubidium hydroxide (RbOH), sodium hydroxide (NaOH), strontium hydroxide (Sr(OH)₂), or beryllium hydroxide (Be(OH)₂).

### Mineral Processing

Additionally, the disclosed apparatuses and methods may be useful in mineral processing. In one example, during the extraction of beryllium metal from ores of beryl and bertrandite, beryllium hydroxide is a by-product, which could be corrosive to the equipment. In another example, processing bauxite ore is performed at high temperature and pressure. Although present in only a small amount, water is introduced in the form of hydrated rocks and as a byproduct of the process. Bauxite ore is a mixture of hydrated aluminum oxides and compounds of other elements such as iron. Aluminum oxides and hydroxides are amphoteric, meaning that they are both acidic and basic. The solubility of Al(III) in water is very low but increases substantially at either high or low pH. In the Bayer process, bauxite ore is heated in a pressure vessel along with a sodium hydroxide solution (caustic soda) at a temperature of 150 to 200° C. At these temperatures, the aluminum is dissolved as sodium aluminate (primarily [Al(OH)₄]—) in an extraction process. After separation of the residue by filtering, gibbsite is precipitated when the liquid is cooled and then seeded with fine-grained aluminum hydroxide crystals from previous extractions. The precipitation may take several days without addition of seed crystals.

The extraction process (digestion) converts the aluminum oxide in the ore to soluble sodium aluminate, NaAlO₂, according to the chemical equation:

Al₂O₃+2 NaOH→₂ NaAlO₂+H₂O

This treatment also dissolves silica, forming sodium silicate:

2 NaOH+SiO₂→Na₂SiO₃+H₂O

The other components of bauxite, however, do not dissolve. In some examples, lime is added at this stage to precipitate the silica as calcium silicate. The solution is then clarified by filtering off the solid impurities, commonly with a rotary sand trap and with the aid of a flocculant such as starch, to remove the fine particles. The undissolved waste after the aluminium compounds is extracted, bauxite tailings, contains iron oxides, silica, calcia, titania and some unreacted alumina. The original process was that the alkaline solution was cooled and treated by bubbling carbon dioxide through it, a method by which aluminium hydroxide precipitates:

2 NaAlO₂+3 H₂O+CO₂→2 Al(OH)₃+Na₂CO₃

But later, this gave way to seeding the supersaturated solution with high-purity aluminum hydroxide (Al(OH)₃) crystal, which eliminated the need for cooling the liquid and was more economically feasible:

2 H₂O+NaAlO₂→Al(OH)₃+NaOH

Some of the aluminum hydroxide produced is used in the manufacture of water treatment chemicals such as aluminum sulfate, PAC (Polyaluminum chloride) or sodium aluminate. A significant amount is also used as a filler in rubber and plastics as a fire retardant. Some 90% of the gibbsite produced is converted into aluminum oxide, Al₂O₃, by heating in rotary kilns or fluid flash calciners to a temperature of about 1470 K.

2 Al(OH)₃→Al₂O₃+3 H₂O

The left-over, ‘spent’ sodium aluminate solution is then recycled. Apart from improving the economy of the process, recycling accumulates gallium and vanadium impurities in the liquors, so that they can be extracted profitably.

Organic impurities that accumulate during the precipitation of gibbsite may cause various problems, for example high levels of undesirable materials in the gibbsite, discoloration of the liquor and of the gibbsite, losses of the caustic material, and increased viscosity and density of the working fluid. For bauxites having more than 10% silica, the Bayer process becomes uneconomic because of the formation of insoluble sodium aluminum silicate, which reduces yield, and so an alternative process could provide advantages, such as use of the apparatuses and methods in accordance with the present disclosure.

For context, 1.9-3.6 tons of bauxite is required to produce 1 ton of aluminum oxide. This is due to a majority of the aluminum in the ore being dissolved in the process. Energy consumption is between 7 GJ/tonne to 21 GJ/tonne (depending on process), of which most is thermal energy. Over 90% (95-96%) of the aluminum oxide produced is used in the Hall-Héroult process to produce aluminum.

### EXAMPLES

### Example 1: Use of an Apparatus Including a Silicone Liner Under Reaction Conditions Requiring a Corrosive Base, Heat, and Pressure in the Manufacture of Paper From Corn Stove

A silicone pressure vessel liner in the shape of a bowl was placed into the stainless-steel bowl of a 6-quart pressure cooker. Prior to placement of the silicone receptacle, the stainless-steel bowl was filled with 1 quart of water. Accordingly, the bottom and external sides of the silicone liner were in contact with the water and the stainless-steel bowl holding the water.

A 5% solution of sodium hydroxide (pH 14) was added to the silicone receptacle along with ingredients for the production of paper from corn stove. Neither processed material nor reagents were in direct contact with the stainless-steel bowl containing the water. The pressure cooker was then sealed, and a program was initiated expose the contents to a peak temperature of at least about 100° C., preferably about 121° C. (250° F.), and a peak pressure of about 1.0 to 1.1 bar (about 15 psi) for a predetermined amount of time.

After completion of the program, the contents were allowed to cool prior to removing the silicone receptacle from the pressure cooker. The resulting reaction material, the silicone, and stainless-steel containers were evaluated for signs of degradation, of which there was none. The silicone pressure vessel liner showed no signs of degradation, and the water in the pressure cooker was clear, indicating an absence of material reactivity or degradation of the liner.

Previous experimentation with other materials led to unsatisfactory results, i.e., degradation of reaction equipment and subsequent contamination of reaction materials. For example, the reaction was attempted with several different types of glass and arrangements thereof. Glass began to wear away upon its first direct exposure to the reaction materials in combination with the heat and pressure conditions. With each exposure, the glass gradually became cloudier, indicating degradation. The glass reaction equipment also became slippery to manually handle, introducing an additional hazardous element to the reaction.

These reaction conditions were also attempted in containers composed of stainless steel or aluminum. The degradation of aluminum was immediately evident, as pitting and obvious degradation of the surface were observed. Experimentation with stainless steel resulted in changes in color and surface texture, such as pitting and etching. Additionally, when polymeric resin coatings were employed to protect the stainless steel or aluminum surfaces, the coating also showed signs of degradation, such as visible alterations in surface texture and peeling.

While a classic method of producing paper from corn stove involved use of wooden reaction equipment, it was determined that heating the aqueous alkoxide with corn stove close to boiling or under pressure would have been too dangerous in today's industrial environment, e.g., considering the flammability of wood, and extremely difficult to execute.

### EQUIVALENTS AND SCOPE

Those skilled in the art will recognize or be able to ascertain using no more than routine experimentation many equivalents to the specific embodiments described herein. The scope of the present invention is not intended to be limited to the above, but rather is as set forth in the appended claims.

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, it is to be understood that the invention encompasses all variations, combinations, and permutations in which one or more limitations, elements, clauses and descriptive terms, from one or more of the listed claims is introduced into another claim. For example, any claim that is dependent on another claim can be modified to include one or more limitations found in any other claim that is dependent on the same base claim.

Where elements are presented as lists, e.g., in Markush group format, it is to be understood that each subgroup of the elements is also disclosed, and any element(s) can be removed from the group. It should be understood that, in general, where the invention, or aspects of the invention is/are referred to as comprising particular elements, features, etc., certain embodiments of the invention or aspects of the invention consist, or consist essentially of, such elements, features, etc. For purposes of simplicity, those embodiments have not been specifically set forth in haec verba herein. It is also noted that the term “comprising” is intended to be open and permits the inclusion of additional elements or steps.

Where ranges are given, endpoints are included. Furthermore, it is to be understood that unless otherwise indicated or otherwise evident from the context and understanding of one of ordinary skill in the art, values that are expressed as ranged can assume any specific value or sub-range within the stated ranges in different embodiments of the invention, to the tenth of the unit of the lower limit of the range, unless the context clearly dictates otherwise.

The term “about” or “approximately” means within an acceptable error range for the particular value as determined by one of the ordinary skill in the art, which will depend in part on how the value is measured or determined, e.g., the limitations of the measurement system. For example, “about” can mean within 1 or more than 1 standard deviation, per the practice in the art. Alternatively, “about” can mean a range of up to 20%, up to 10%, up to 5% or up to 1% of a given value. Alternatively, the term can mean within an order of magnitude, for example within 5-fold, or within 2-fold, of a value. Where particular values are described in the application and claims, unless otherwise stated the term “about” meaning within an acceptable error range for the particular value should be assumed.

I claim:

1. An apparatus comprising a body having an outer housing and an inner chamber, a silicone pressure vessel liner received therein having an interior space and an exterior surface, and a detachable lid that covers the body.

2. The apparatus of claim 1, wherein the inner chamber comprises an interior bottom and side walls; and wherein the exterior surface of the silicone pressure vessel liner contacts the interior bottom and the side walls of the inner chamber.

3. The apparatus of claim 2, wherein the silicone pressure vessel liner is removeable from the inner chamber of the apparatus.

4. The apparatus of claim 2, wherein the silicone pressure vessel liner coats the interior bottom and the side walls of the inner chamber.

5. An apparatus comprising a body having an outer housing and an inner chamber with a detachable lid that covers the body, wherein a removeable reaction vessel having an inner space and an exterior surface is positioned in the inner chamber; and wherein a silicone pressure vessel liner having an interior space is positioned in the inner space of the removeable reaction vessel.

6. The apparatus of claim 5, wherein the inner space of the removeable reaction vessel comprises an inside bottom and side walls; and wherein the exterior surface of the silicone pressure vessel liner contacts the inside bottom and side walls of the removeable reaction vessel.

7. The apparatus of claim 6, wherein the silicone pressure vessel liner is removeable from the inner space of the removeable reaction vessel.

8. The apparatus of claim 6, wherein the silicone pressure vessel liner coats the inside bottom and side walls of the removeable reaction vessel.

9. The apparatus of claim 1, wherein the interior space of the silicone pressure vessel liner has a volume capacity of up to and including about 100 L, 250 L, 500 L, 750 L, 1000 L, 5000 L, 10,000 L, 15,000 L, 20,000 L, 25,000 L, or 50,000 L.

10. The apparatus of claim 9, wherein the interior space of the silicone pressure vessel liner has a volume capacity of about 1 L, 5 L, 10 L, 15 L, 20 L, 25 L, 30 L, 35 L, 40 L, 45 L, 50 L, 55 L, 60 L, 65 L, 70 L, 75 L, 80 L, 85 L, 90 L, 95 L, or 100 L.

11. The apparatus of claim 1, wherein the apparatus is a countertop pressure cooker or a reactor.

12. The apparatus of claim 11, wherein the reactor is a flow chemical reactor, a stirred tank reactor, a high-pressure reactor, a hydrothermal reactor, a supercritical fluid reactor, a batch reactor, a fixed bed reactor, a tubular reactor, a continuous stirred reactor, a packed bed reactor, or a multi-purpose reactor.

13. A method of performing a chemical reaction in the silicone pressure vessel liner of claim 1, comprising exposing a reaction mixture comprising a corrosive base to heat and pressure.

14. A method of exposing a reaction mixture comprising a corrosive base to heat and pressure, wherein the corrosive base is in contact with a material comprising silicone and the material comprising silicone is housed within a pressure vessel.

15. The method of claim 13, wherein the corrosive base is aluminum hydroxide (Al(OH)₃), barium hydroxide (Ba(OH)₂), beryllium hydroxide (Be(OH)₂), calcium hydroxide (Ca(OH)₂), cesium hydroxide (CsOH), lithium hydroxide (LiOH), magnesium hydroxide (Mg(OH)₂), potassium hydroxide (KOH), rubidium hydroxide (RbOH), sodium hydroxide (NaOH), strontium hydroxide (Sr(OH)₂), or any combination thereof.

16. The method of claim 13, wherein the concentration % (v/v) of the corrosive base in the reaction mixture is about 1% to 95%.

17. The method of claim 13, wherein the reaction mixture is exposed to a temperature of up to 250° C. and a pressure of up to 2.0 bar.

18. The method of claim 13, wherein the method reduces or prevents degradation of structural materials and contamination of the reaction product.

19. The method of claim 18, wherein the structural materials comprise glass, resin, a metal, ceramic, or a combination thereof.

20. The method of claim 19, wherein the metal is any one of aluminum, copper, iron, steel, or a combination thereof.
